(19) United States
(12) Patent Application Publication
(10) Pub. No.: US 2026/0235107 A1
(43) Pub. Date: Aug. 13, 2026

(54) A Method for Controlling the Position of a Blade Lifting Yoke and a Blade Lifting Yoke for a Rotor Blade for a Wind Turbine

(71) Applicant: LIFTRA IP APS, Aalborg SV (DK)

(72) Inventors: Per Eske Fenger, Terndrup (DK); Alexander Becsei Christiansen, Aalborg SV (DK)

(21) Appl. No.: 19/153,336

(22) PCT Filed: Feb. 1, 2024
(86) PCT No.: PCT/EP2024/052526

§ 371 Date: Aug. 3, 2025

(30) Foreign Application Priority Data
Feb. 2, 2023 (DK) PA202370062

(51) Int. Cl. F03D 13/10; B66C 1/10; B66C 13/08; B66C 23/18

(52) U.S. Cl. CPC F03D 13/104; B66C 1/108; B66C 13/085; B66C 23/185; F05B 2230/61

(57) ABSTRACT

A method for controlling the position of a blade lifting yoke for a rotor blade for a wind turbine is disclosed. The blade lifting yoke includes a yoke unit and a suspension unit connected to a crane at a crane attachment point. The suspension unit comprises a plurality of actuators each being attached to the yoke unit at a yoke attachment point and extending from the yoke attachment point towards the crane attachment point, so that the actuators are angled in relation to each other. A first actuator, a second actuator, and a third actuator are controlled individually by a control unit, thereby changing the length of at least one of the first actuator, the second actuator, and the third actuator and moving the position of the lower clamping member relative to the crane attachment point.

### CROSS-REFERENCE TO RELATED APPLICATIONS

This application is the national phase of, and claims priority to, International Application No. PCT/EP 2024/052526, filed 1 Feb. 2024, which claims priority to Danish Patent Application No. PA 2023 70062, filed 2 Feb. 2023.

### TECHNICAL FIELD

The invention relates to a method for controlling the position of a blade lifting yoke for a rotor blade for a wind turbine. The invention further relates to a blade lifting yoke for a rotor blade for a wind turbine.

### BACKGROUND ART

A blade lifting yoke is used for holding a rotor blade to be mounted on a wind turbine during lifting from a position on the ground or on a vessel to the nacelle of the wind turbine using a crane. The rotor blade is held by the blade lifting yoke in such a manner that the longitudinal axis of the rotor blade extends in parallel with the longitudinal direction of the blade lifting yoke.

When attaching rotor blades to the hub of a wind turbine, bolts on the root of the rotor blade need to be aligned precisely with openings in the hub. This may be done by using the crane to move the entire blade lifting yoke holding the rotor blade, by rotating the hub, and/or by changing the pitch of the hub. Hydraulically driven blade pitch systems of wind turbines, however, cannot be moved freely due to the limitation entailed by the stroke length of the hydraulic cylinder, and electrically operated blade pitch systems can only be moved if the wind turbine already has a supply of power. This is sometimes not the case, particularly off shore.

Some prior art blade lifting yokes have the possibility for tilting and pitching the rotor blade by extending or shortening an actuator, typically a hydraulic cylinder, but as rotor blades become still larger, small changes in position at the blade lifting yoke may result in large movements at the root. This makes it difficult to handle large rotor blades with sufficient precision, particularly during high winds.

Another issue, which has become increasingly problematic with larger rotor blades, is that the blade lifting yoke also needs to be larger and stronger, making it more difficult to control when latching onto and releasing the rotor blade. The latter may result in the blade lifting yoke slipping off the rotor blade prematurely and being in danger of swinging back, hitting the rotor blade, or in that the load of the blade lifting yoke is carried by the rotor blade, potentially overloading the rotor blade. When seen in the longitudinal direction, blade lifting yokes typically have the overall shape of the letter C, spanning either the leading edge or the trailing edge of the rotor blade, while the opposite edge of the rotor blade projects away from the body of the C. This entails an unbalance in the blade lifting yoke when not carrying a rotor blade, which is often compensated for by the provision of counterweights at the free ends of the legs of the C, thereby reducing the risk of a swinging motion when the rotor blade is released. The counterweights, however, make the blade lifting yoke even heavier and more difficult to handle. The delicate weight balance also entails that it is typically necessary to have several different blade lifting yokes for different sizes and types of rotor blades.

### SUMMARY OF INVENTION

With this background, it is an object of the invention to provide a method allowing a more precise control of the blade lifting yoke during operation.

This and further objects are achieved with a method for controlling the position of a blade lifting yoke for a rotor blade for a wind turbine. The blade lifting yoke includes a yoke unit and a suspension unit. The yoke unit includes a base section and a holding device, and the suspension unit is connected to a crane at a crane attachment point. The holding device includes a lower clamping member configured to support the rotor blade and an upper clamping member configured to press the rotor blade against the lower clamping member. The upper clamping member is arranged at a distance from the lower clamping member in a height direction, which is perpendicular to the longitudinal direction. The suspension unit comprises a plurality of actuators each being attached to the yoke unit at a yoke attachment point and extending from said yoke attachment point towards the crane attachment point. The yoke attachment points are distanced from each other so that the actuators are angled in relation to each other. A first actuator, a second actuator, and a third actuator are controlled individually by a control unit, thereby changing the length of at least one of the first actuator, the second actuator, and the third actuator and moving the position of the lower clamping member relative to the crane attachment point. The yoke attachment points at which the first actuator and the second actuator are attached are arranged at a distance from each other in the longitudinal direction. The yoke attachment points at which the third actuator are attached are arranged at a distance in a width direction from a least one of the yoke attachment points at which the first actuator and the second actuator are attached, the width direction being perpendicular to the longitudinal direction and to the height direction.

This allows the total centre of gravity of the blade lifting to be kept in the same vertical plane as the crane attachment point when viewed in the longitudinal direction, even when loads change, for example when latching onto or releasing a rotor blade. With the centre of gravity vertically below the crane attachment point, it is possible to pitch the blade lifting yoke holding the rotor blade about the centre of gravity, which has not been possible with prior art blade lifting yokes. Thereby it becomes easier to control the pitch of the blade lifting yoke, making the handling of the rotor blade less sensitive to external factors, such as wind. A precise control of pitch may especially be advantageous when connecting a rotor blade to the hub of the wind turbine, where the geometrical centre of the blade root needs to be aligned with the geometrical centre of the hub. Controlling the pitch in this way also allows the rotor blade to be deliberately pitched with high precision to align bolts on the blade root with openings in the hub, because undesirable translation of the geometric centre of the rotor blade centre as a consequence of the pitching is limited when the geometric centre of the rotor blade is close to the centre of gravity.

The centre of gravity may also be kept in the same vertical plane as the crane attachment point when viewed in the width direction, thereby providing tilt stability and/or control in addition to or instead of pitch stability and/or control. This may for example allow the root of the rotor blade to be kept substantially stationary while tilting the rest of the rotor blade, thereby for example allowing an alignment of the root with the hub of a wind turbine in case the bolts of the root are angled in relation to the openings in the hub in which they are to be inserted.

Another advantage of keeping the centre of gravity aligned with the crane attachment point is that the same blade lifting yoke may be used for many different rotor blade designs, where the centre of gravity of the rotor blade and hence also the total centre of gravity will be located in many different positions relative to the lower clamping member. This may for example result from the centre of gravity being located differently within the blade profile or from the rotor blade having a different size or weight. The shift in the position of the centre of gravity may then be compensated for by changing the lengths of one or more of the actuators before commencing the lift.

In addition to becoming more stable when carrying a rotor blade, the ability to move the position of the lower clamping member relative to the position of the crane attachment point also allows for a better stability of the blade lifting yoke itself by allowing for example to compensate for one side being heavier than the other. Thereby the need for counterweights is reduced or possibly even eliminated.

Counterweights are typically provided high on the blade lifting yoke when seen in the height direction and removing or reducing them will therefore result in the centre of gravity of the blade lifting yoke seen in the longitudinal direction being lowered. This in turn means that the centre of gravity of the blade lifting yoke and consequently also the total centre of gravity of the blade lifting yoke and the rotor blade comes closer to the geometrical centre of the root of a rotor blade carried by the blade lifting yoke. As also described above, this will facilitate a precise pitching of the rotor blade and thus ease connection to the hub of the wind turbine.

The actuators may for example be chosen from the group consisting of hydraulic linear cylinders, electrical linear cylinders, cables systems including one or more winches with electrical or hydraulic drives, rack-and-pinions, threaded rods, and combinations thereof.

The yoke attachment points may be provided on the holding device(s) or on the base section(s), depending for example of the load bearing capacity of the different parts of the yoke unit. To allow optimal capacity for adjusting the position, such as the pitch, of the rotor blade, the yoke attachment points are advantageously positioned far from each other. The yoke attachment points may for example be embodied as brackets, braces, hooks, bolts, threaded openings, or the like. Actuators may be provided with hooks, shackles, bolts or the like for interconnection with the yoke attachment points.

The holding device or the base section may comprise a frame having the shape of the letter C and spanning an edge of the rotor blade, preferably the leading edge of the rotor blade during operation.

In one embodiment, the method further comprises changing the length of a fourth actuator, which attached to a yoke attachment point arranged at a distance in the longitudinal direction from the yoke attachment points at which the first actuator is attached and in the same plane extending in the width direction as the yoke attachment points at which the second actuator is attached, the fourth actuator being controlled individually by the control unit. In this embodiment it may be advantageous that the yoke attachment points at which the first actuator and the third actuator are attached are also arranged in the same plane extending in the width direction, the plane being distanced in the longitudinal direction from plane in which the yoke attachment points at which the second and fourth actuators are attached are located. This allows the use of two sets of actuators when needing to stabilize or change pitch and/or tilt, providing an even better control of the blade lifting yoke. Using two sets of actuators may also reduce torsional loads on the rotor blade.

In one embodiment, a root of the rotor blade is aligned with a hub of the wind turbine by changing the length of actuators attached to yoke attachment points arranged at a distance from each other in the width direction thereby changing the pitch of the rotor blade.

In one embodiment all actuators are shortened to lift the blade lifting yoke or extended to lower the blade lifting yoke. While this is only useful for smaller movements of the blade lifting yoke, it may be advantageous in the final stages of mounting a rotor blade, as this height adjustment may be performed by a yoke operator, thus not involving the crane operator.

If a blade lifting yoke holding a rotor blade is simply lifted and is not affected by external factors, such as wind, the position of the centre of gravity will be substantially constant, but this is rarely the case. It may therefore be advantageous to perform a continuous adjustment of the length of the actuators. As an example, when a rotor blade is released, the hold of the blade lifting yoke is typically released gradually, resulting in the centre of gravity gradually moving from the position of the total centre of gravity to the position of the centre of gravity of blade lifting yoke. By gradually adjusting the lengths of the actuators, a good control of the blade lifting yoke is maintained at all times, thereby for example reducing the risk of the blade lifting device moving abruptly at the end of the release sequence.

The lengths of the actuators may be changed following a predetermined pattern, which may be programmed into the control unit(s), but it is presently considered advantageous that changed happen in response to changes in the loads affecting the blade lifting yoke. A combination, where several predetermined patterns are initiated following input from an operator that a certain process step has been reached or completed, is also possible, just as some parts of a lift of a rotor blade may follow a predetermined pattern, while others are controlled based on live data and/or user input only.

The control unit(s) may be in data communication with a control system, such as an external control system, which may be performing live calculations of the necessary changes to the lengths of the actuators. These calculations may be based on data obtained from sensors provided on or at the blade lifting yoke, on weather data, and/or on user input, such as an indication from an operator that the rotor blade needs to be lowered, lifted, tilted, or pitched. Sensors provided on or at one or more actuators, such as pressure sensors or force sensors, may provide data on the loads affecting each actuator. Other examples of sensors are stroke length sensors and angle sensors. It is also possible to use vision based sensor systems for providing data on the state and/or position of the actuators, the yoke unit or other relevant parts.

In a second aspect of the invention the above and further objects are achieved with a blade lifting yoke of the kind mentioned above, which is furthermore characterised in that a first actuator, a second actuator, and a third actuator are individually controllable by a control unit, each of the actuators having an adjustable length and being controllable at least so that one may be extended while the other is shortened, and that the yoke attachment points at which said first actuator and said second actuator are attached are arranged at a distance from each other in the longitudinal direction, and that the yoke attachment points at which the third actuator is attached is arranged at a distance in a width direction from a least one of the yoke attachment points at which the first actuator and the second actuator are attached, the width direction being perpendicular to the longitudinal direction and to the height direction.

The above description of the method contains several examples of embodiments of the blade lifting yoke and it is to be understood that these and the advantages provided by them also apply to the second aspect of the invention. Likewise, it is to be understood that embodiments and advantages described with reference to one aspect of the invention below, also apply to the other aspect even unless otherwise stated. In general, embodiments and advantages are described only with reference to one embodiment to avoid undue repetition.

### BRIEF DESCRIPTION OF DRAWINGS

In the following description embodiments of the invention will be described with reference to the schematic drawings, in which:

FIG. 1 is a schematic view of a wind turbine and a crane lifting a blade lifting yoke holding a rotor blade,

FIG. 2 is a perspective view of a section of a rotor blade carried by a blade lifting yoke hanging from a crane,

FIG. 3 is a cross-sectional view of a rotor blade carried by a blade lifting yoke,

FIG. 4 is a cross-sectional view of a blade lifting yoke hanging from a crane and a rotor blade,

FIG. 5 corresponds to FIG. 4 but with the rotor blade carried by the blade lifting yoke,

FIG. 6 corresponds to FIG. 5 but showing three different positions of the blad lifting yoke, and

FIG. 8 is a perspective view of another blade lifting yoke holding a rotor blade.

### DESCRIPTION OF EMBODIMENTS

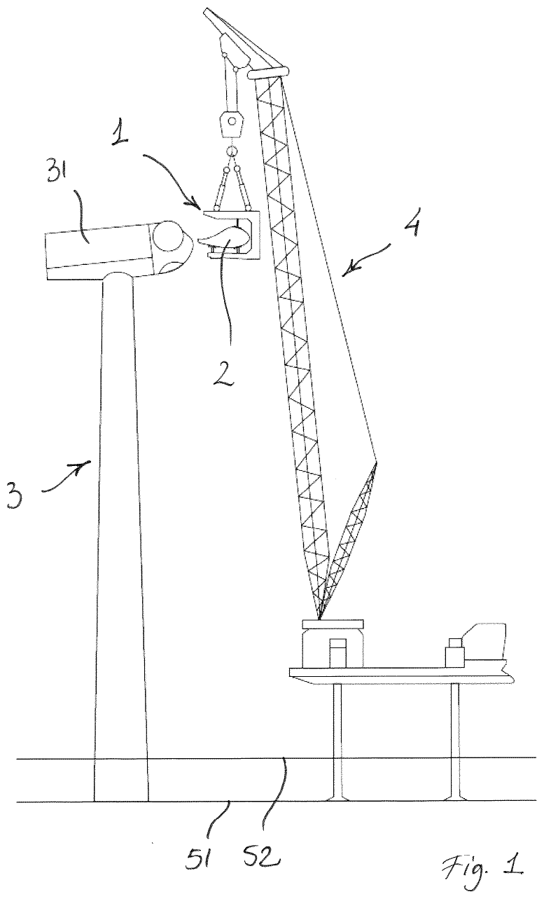

Referring initially to FIG. 1, a blade lifting yoke 1 holds a rotor blade 2 while being lifted to the nacelle 31 of a wind turbine 3 by a crane 4. Here, it is shown in an off-shore installation, where the crane and the wind turbine are both supported on a sea bed 51 below sea level 52, but it is to be understood that the invention is not limited to off-shore uses and may be used for any operation involving lifting a rotor blade.

In the following, the same reference number will be used for elements having substantially the same function, even if they are not necessarily identical.

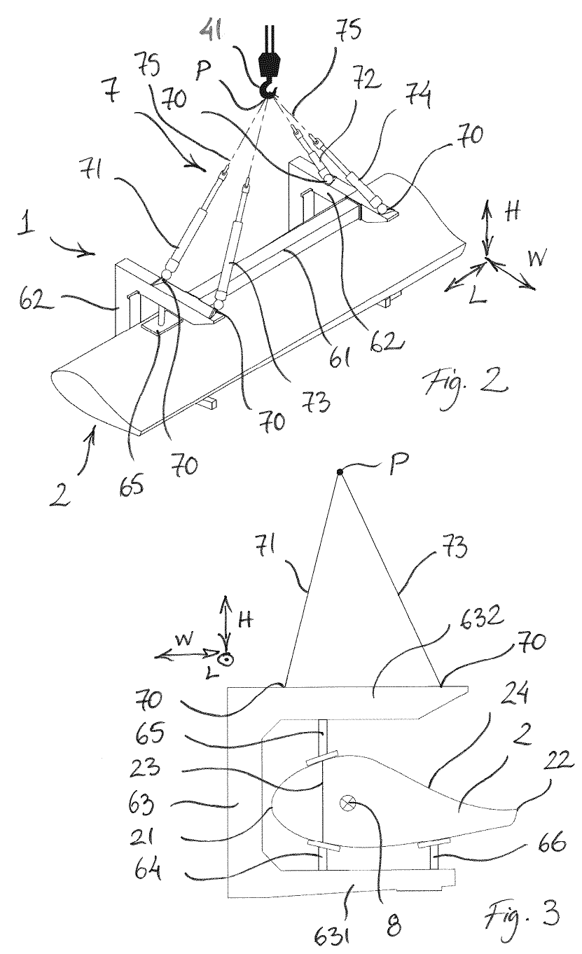

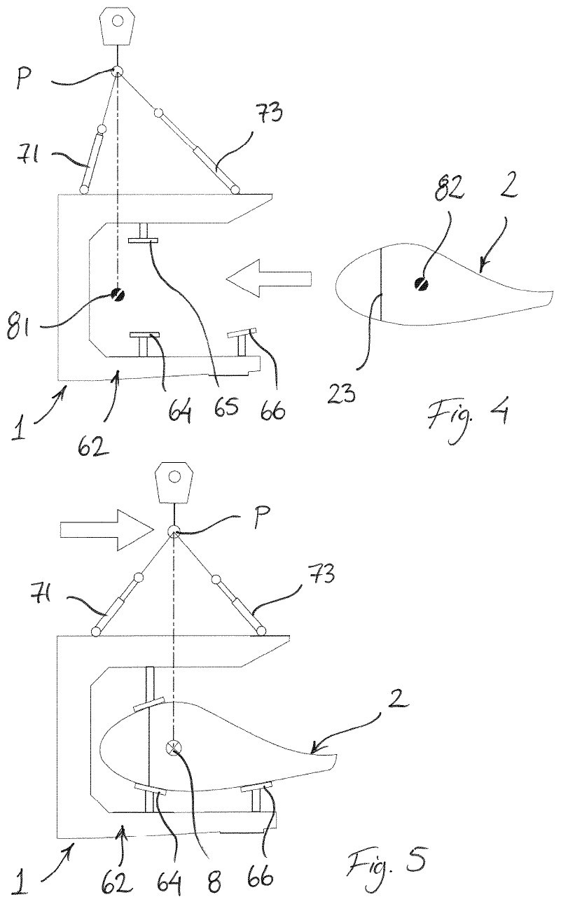

The blade lifting yoke 1 is shown in more detail in FIGS. 2 and 3 holding a section of a rotor blade 2. The blade lifting yoke comprises a yoke unit 6 and a suspension unit 7, and the yoke unit in turn comprises a base section 61 and two holding devices 62 arranged at opposite ends of the base section at a distance from each other in a longitudinal direction L.

As is best seen in FIG. 2, the suspension unit 7 is connected to a hook 41 of a crane at a crane attachment point P.

Each holding device 62 comprises frame 63 having the shape of the letter C with a lower clamping member 64 on the lower leg 631 of the C supporting the rotor blade 2, and an upper clamping member 65 on the upper leg 632 pressing the rotor blade against the lower clamping member. The C-shape here spans the leading edge 21 of the rotor blade and the trailing edge 22 extend out of the C-shape. This is considered advantageous as the part of the rotor blade closer to the leading edge is heavier than the part closer to the trailing edge, but it is not excluded that the C-shape might span the trailing edge.

The lower clamping member 64 and the upper clamping member 65 are arranged at a distance from each other in a height direction H, which is perpendicular to the longitudinal direction L. A width direction D is perpendicular both to the longitudinal direction and to the height direction. Here the holding device further comprises a supporting member 66 arranged at a distance from the lower clamping member 64 in the width direction.

As shown in FIG. 3, which is viewed in the longitudinal direction L, a reinforcing web 23 extends vertically inside the rotor blade 2 and the lower clamping member 64 and an upper clamping member 65 engage the rotor blade where the web joins the shell 24 of the rotor blade. The total centre of gravity 8 of the blade lifting yoke and the rotor blade is located close to the web, slightly towards the trailing edge of the rotor blade.

In the embodiment in FIG. 2, the suspension unit 7 comprises four yoke attachment points 70, two at each holding device 62 distanced from each other in the width direction W. An actuator 71, 72, 73, 74 is connected to each yoke attachment point at one end and to cables 75 extending to the crane attachment point P at the other end. As the yoke attachment points 70 are distanced from each other both in the width direction W and in the longitudinal direction L, the actuators extend at angles to each other both in the longitudinal direction and in the width direction. The distance between the yoke attachment points in the width direction is slightly different in FIG. 2 and FIG. 3.

All of the actuators 71, 72, 73, 74 shown in FIG. 2 are hydraulic cylinders, but it is to be understood that other types of actuators may be employed.

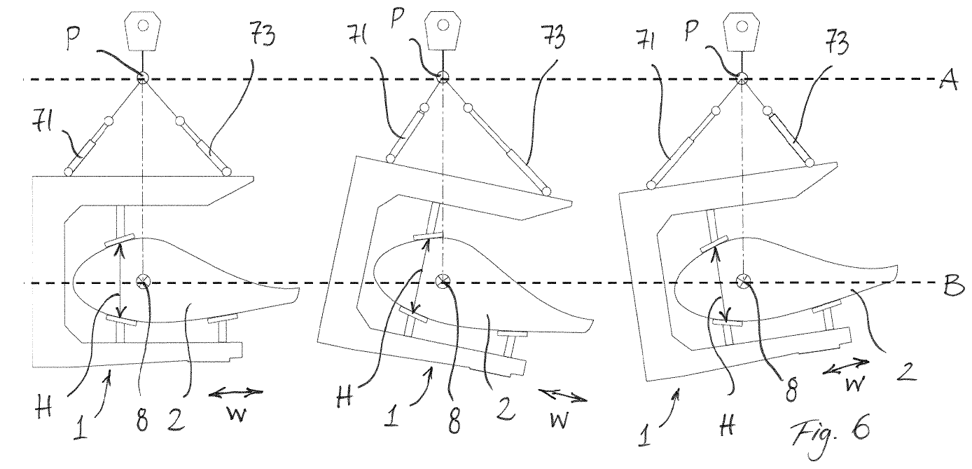

FIG. 4 and FIG. 5 show the process of arranging the rotor blade 2 in/on the blade lifting yoke 1.

In FIG. 4, the centre of gravity 81 of the blade lifting yoke 1 alone is shown located to the left of the clamping members 64, 65 and the centre of gravity 82 of the rotor blade 2 alone is shown to the right of the web 23. The crane attachment point P is located vertically above the centre of gravity 81 of the blade lifting yoke 1 as indicated by the dash-dotted line. This has been achieved by shortening the lefthand actuator 71 and extending the righthand actuator 73 compared to what was shown in FIG. 2.

When inserting the rotor blade 2 into holding devices 62 as indicated by the arrow in FIG. 4 (or displacing the blade lifting yoke 1 in the opposite direction) the rotor blade comes to rest on the lower clamping member 64 and the supporting member 66 and the total centre of gravity 8 is then located as shown in FIG. 5. To compensate for this displacement of the centre of gravity of the load carried by the crane, the lefthand actuator 71 is extended and the righthand actuator 73 shortened so that the crane attachment point P is displaced to the right as indicated by the arrow until located vertically above the centre of gravity 8.

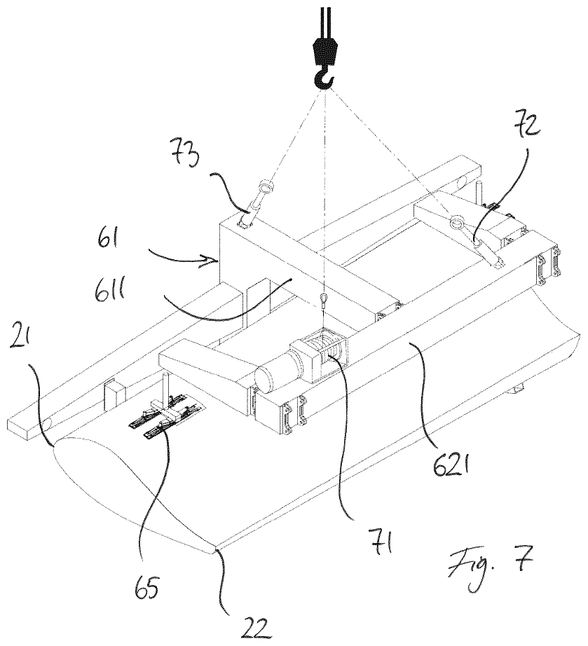

FIG. 6 shows three positions of the same blade lifting yoke 1 holding a rotor blade 2, the lefthand position corresponding to the illustration in FIG. 5. In the position shown at the centre of FIG. 6, the blade lifting yoke 1 has been pitched to the right by shortening the lefthand actuator 71 and extending the righthand actuator 73 and in the position shown to right it has been pitched to the left by extending the lefthand actuator 71 and shortening the righthand actuator 73. As indicated by lines A and B, the vertical distance between the crane attachment point P and the centre of gravity 8 remains the same regardless of the pitching, which contributes to the stability and control of the blade lifting yoke 1 when in use.

A pitching as shown in FIG. 6 may serve several different purposes including facilitating latching or release of the rotor blade and compensating for wind loads. It is, however, particularly advantageous in that it allows the root (not shown) of the rotor blade to be aligned with the hub of the wind turbine.

As shown in FIG. 6 the height direction H, which is defined as extending between lower clamping member 64 and the upper clamping member 65, thus turns with the blade lifting yoke when pitched. The same applies to the W direction, which is perpendicular to the height direction.

In the embodiments in FIGS. 2, 4, 5 and 6 the actuators 71, 72, 73, 74 can be shortened and extended independently, but it is also possible to interconnect two actuators, such that a shortening of one results in an extension of the other and vice versa.

Another embodiment of a blade lifting yoke 1 holding a section of a rotor blade 2 is seen in FIG. 7. In this embodiment, the base section 61 has the shape of the letter C and the holding device comprises a lower part (not visible) on the lower leg of the C and an upper part 621 on the upper leg 611 of the C. The C-shape spans the leading edge 21 of the rotor blade and the trailing edge 22 extends out of the C-shape. The upper clamping members 65 are arranged on the upper part 621 of the holding device and it is to be understood that lower clamping members (not visible) are found on the lower part of the holding device, such that the rotor blade is held in the same way as shown in FIG. 3, except for this embodiment does not include a support member.

In FIG. 7 the first actuator 71 is an electrically operated cable winch, while the second and third actuators 72, 73 are hydraulic actuators as in FIG. 2. This combination is intended to illustrate different embodiments of the actuators, but it will usually be advantageous that all of the actuators are of the same type.

The yoke attachment points to which the first and second actuator 71, 72 are connected are here found on the upper part 621 of the holding device and the yoke attachment points to which the third actuator 73 is connected is on the base section 61.

The embodiments of different parts of the blade lifting yoke 1 described herein may be combined in different ways, which may result in blade lifting yokes different from those shown. The embodiments shown in the drawing are only intended as examples and variations are possible within the scope of the claims.

1. A method for controlling the position of a blade lifting yoke for a rotor blade for a wind turbine, said blade lifting yoke comprising:
a yoke unit and a suspension unit, said yoke unit including a base section and a holding device, and said suspension unit being connected to a crane at a crane attachment point;
wherein the holding device comprises a lower clamping member configured for supporting the rotor blade and an upper clamping member configured for pressing the rotor blade against the lower clamping member and being arranged at a distance from the lower clamping member in a height direction, which is perpendicular to the longitudinal direction; and
wherein the suspension unit comprises a plurality of actuators each being attached to the yoke unit at a yoke attachment point and extending from said yoke attachment point towards the crane attachment point, and said yoke attachment points being distanced from each other so that the actuators are angled in relation to each other;
the method comprising:
changing a length of at least one of a first actuator, a second actuator, and a third actuator of the plurality of actuators, wherein each of the first actuator, the second actuator and the third actuator is controlled individually via a control unit; and
moving a position of the lower clamping member relative to the crane attachment point, wherein the yoke attachment points at which said first actuator and said second actuator are attached are arranged at a distance from each other in the longitudinal direction, and wherein the yoke attachment points at which said third actuator is attached is arranged at a distance in a width direction from a least one of the yoke attachment points at which said first actuator and said second actuator are attached, said width direction being perpendicular to the longitudinal direction and to the height direction.

2. The method according to claim 1, further comprising changing a length of a fourth actuator of the plurality of actuators, the fourth actuator being attached to a yoke attachment point arranged at a distance in the longitudinal direction from the yoke attachment points at which said first actuator is attached and in the same plane extending in the width direction as the yoke attachment points at which said second actuator is attached, said fourth actuator being controlled individually by the control unit.

3. The method according to claim 1, wherein a root of the rotor blade is aligned with a hub of the wind turbine by changing the length of actuators attached to yoke attachment points arranged at a distance from each other in the width direction thereby changing the pitch of the rotor blade.

4. The method according to claim 1, wherein all actuators are shortened to lift the blade lifting yoke or extended to lower the blade lifting yoke.

5. The method according to claim 1, wherein the lengths of the actuators are changed in response to changes in the loads affecting the blade lifting yoke.

6. The method according to claim 1, wherein the control units in data communication with an external control system.

7. The method according to claim 1, wherein calculations of necessary changes to the length of one or more actuators are made based on data obtained from sensors provided on or at the blade lifting yoke, on weather data, and/or on user input.

8. A blade lifting yoke for a rotor blade for a wind turbine, said blade lifting yoke comprising:
a yoke unit comprising a base section and a holding device; and
a suspension unit comprising a crane attachment point;
wherein:
the holding device comprises a lower clamping member configured for supporting the rotor blade and an upper clamping member configured for pressing the rotor blade against the lower clamping member and being arranged at a distance from the lower clamping member in a height direction, which is perpendicular to the longitudinal direction;
the suspension unit comprises a plurality of actuators each being attached to the yoke unit at a yoke attachment point and extending from said yoke attachment point towards the crane attachment point, and said yoke attachment points being distanced from each other so that the actuators are angled in relation to each other;
a first actuator, a second actuator, and a third actuator of the plurality of actuators are individually controllable by a control unit, each of the actuators having an adjustable length and being controllable at least so that one may be extended while the other is shortened;
the yoke attachment points at which said first actuator and said second actuator are attached are arranged at a distance from each other in the longitudinal direction, and
the yoke attachment points at which said third actuator is attached is arranged at a distance in a width direction from a least one of the yoke attachment points at which said first actuator and said second actuator are attached, said width direction being perpendicular to the longitudinal direction and to the height direction.

9. The blade lifting yoke according to claim 8, wherein the plurality of actuators further comprises a fourth actuator, the fourth actuator being arranged at a distance from the first actuator in the longitudinal direction and in the same plane extending in the width direction as the second actuator, wherein the fourth actuator is controlled individually by the control unit.

10. The blade lifting yoke according to claim 8, wherein the blade lifting yoke comprises two holding devices arranged at opposite ends of the base section at a distance from each other in the longitudinal direction and the first actuator and the third actuator are located at one holding device and the second actuator is located at the other holding device.

11. The blade lifting yoke according to claim 9, wherein the blade lifting yoke comprises two holding devices arranged at opposite ends of the base section at a distance from each other in the longitudinal direction and the first actuator and the third actuator are located at one holding device and the second and the fourth actuator are located at the other holding device.

12. The method according to claim 2, wherein a root of the rotor blade is aligned with a hub of the wind turbine by changing the length of actuators attached to yoke attachment points arranged at a distance from each other in the width direction thereby changing the pitch of the rotor blade.

13. The blade lifting yoke according to claim 8, wherein all actuators are configured to be shortened via the control unit to lift the blade lifting yoke or extended to lower the blade lifting yoke.

14. The blade lifting yoke according to claim 8, wherein the lengths of the actuators are configured to be changed via the control unit in response to changes in the loads affecting the blade lifting yoke.

15. The method according to claim 1, wherein the control unit comprises a plurality of control units, and wherein the control units are in data communication with an external control system.

16. The blade lifting yoke of claim 8, wherein the control unit is in data communicate with an external control system.

17. The blade lifting yoke according to claim 8, wherein the control unit comprises a plurality of control units, and wherein the control units are in data communication with an external control system.
